(19) United States
(12) Patent Application Publication
(10) Pub. No.: US 2009/0065418 A1
(43) Pub. Date: Mar. 12, 2009

(54) Filter Press With Novel Filter Cake Release Mechanism

(76) Inventors: Horst Christian Schulte, Johannesburg (ZA); Percy Forssman, Pretoria (ZA)

Correspondence Address: THE NATH LAW GROUP, 112 South West Street, Alexandria, VA, 22314, US

(21) Appl. No.: 11/918,142

(22) PCT Filed: Apr. 3, 2006
(86) PCT No.: PCT/IB2006/050995

§ 371 Date: Aug. 19, 2008

(30) Foreign Application Priority Data
Apr. 4, 2005 (ZA) 2005/02695

(51) Int. Cl. B01D 25/34; B03C 1/30

(52) U.S. Cl. 210/223; 210/225

(57) ABSTRACT

The invention provides a filter press comprising a support frame; a plurality of filter plates mounted adjacent one another on the support frame, the filter plates being displaceable between an inoperative position wherein adjacent filter plates are spaced apart, and an operative position wherein adjacent filter plates abut to form filtration cavities between them; the filter plates in their inoperative position being angularly displaceable relative to the support frame; and actuating means adapted angularly to displace the filter plates relative to the support frame so as to discharge filter cake from the filtration cavities.

### FIELD OF THE INVENTION

The invention relates to a filter press, and more particularly, but not exclusively to a filter press having a novel arrangement for releasing filter cakes from filter plates.

### BACKGROUND TO THE INVENTION

Filter presses are generally used to separate solids from liquids, and more particularly to separate a suspension such as slurry into solids and solid-free filtrate by forcing the suspension against a filter cloth that only allows liquid to permeate through it in the form of solid-free filtrate.

A filter press in essence comprises a plurality of filter plates mounted adjacent one another, the filter plates being moveable between an operative position wherein adjacent filter plates abut, and an inoperative position wherein adjacent filter plates are spaced apart. The filter plates are geometrically shaped to define filtration cavities when adjacent filter plates abut. The filter plates have internal inlet conduits for feeding slurry into the filtration cavities, and internal outlet conduits for discharging solid-free filtrate from the filtration cavities. Filter cloths, designed to allow permeation of liquids therethrough, separate the filtration cavities from the internal outlet conduits.

In use the filtration cavities are filled under pressure with a suspension to be separated or filtrated. The liquid portion of the suspension permeates through the filter cloth, and is discharged through the internal outlet conduits. The solid particles remain trapped in the filtration cavities, and accumulate against the filter cloth to form densely packed layer of solid material commonly referred to as a filter cake.

At the end of a filtration cycle, the filter plates are moved to a spaced apart, inoperative position in order for the filter cakes to be discharged, and for the filter cloths to be cleaned. Ideally the filter cakes should automatically slide from the filter plates due to gravitational force, but the filter cakes are often trapped in the filtration cavities whilst also sticking to the filter cloths, thus preventing them from being discharged under gravitational force alone.

Various methods have been proposed to alleviate the above problem. One option is for the filter cloths to be mounted on frames that are individually displaceable relative to the filter plates. During filter cake removal the frames are individually moved away from the vertically orientated filter plates in order for each filter cloth, and the associated filter cake, to be displaced from its filtration cavity. The frames can furthermore individually be tilted to an inclined position, resulting in the filter cake being dislodged from the filter cloth. A disadvantage of this arrangement is that the frames must be displaced sequentially, each being displaced separately in relation to its associated filter plate. This process is time-consuming, reducing the efficiency of the filter press. A further disadvantage is that each frame to which the filter cloth is connected must be independently tiltable which makes the filter press structure mechanically complicated.

Another method of removing filter cakes comprises a filter cake scraping system that is used mechanically to separate the filter cake from the filter cloth. In this system the filter cloth is first removed from the filtration cavity by means of a tiltable frame similar to that described above. A scraping member is subsequently lowered next to a filter plate, and wedges the filter cake from the filter cloth so as to dislodge the filter cake. As in the previous configuration, the filter plates must be sufficiently spaced apart to allow insertion of the scraping device, and the process must therefore be sequential as in the previous example. The scraping device is furthermore of complex configuration as it also comprises a spacer member which is inserted between the filter cloth and the filter plate in order to keep the filter cloth stationary during the wedging operation.

### OBJECT OF THE INVENTION

It is accordingly an object of the invention to provide a filter press which will, at least partially, alleviate the disadvantages mentioned above, and/or which will provide a useful alternative to existing filter presses.

### SUMMARY OF THE INVENTION

According to the invention there is provided a filter press comprising:

a support frame;
a plurality of filter plates mounted adjacent one another on the support frame,
the filter plates being displaceable between an inoperative position wherein adjacent filter plates are spaced apart, and an operative position wherein adjacent filter plates abut to form filtration cavities between them;
the filter plates in their inoperative position being angularly displaceable relative to the support frame; and
   actuating means adapted angularly to displace the filter plates relative to the support frame so as to discharge filter cake from the filtration cavities.

Connecting means may be provided for connecting adjacent filter plates such that the actuating means displaces all or selected filter plates simultaneously. Preferably the plates will be moved in a to and fro motion.

The connecting means may be flexible connecting means, preferably in the form of a chain.

The filter plates may include track engagement means extending from opposite sides thereof for mounting the filter plates on spaced tracks provided on the support frame.

The filter plates may be pivotable about the track engagement means between substantially vertical positions and angularly displaced positions.

Preferably the track engagement means are in the form of rollers or wheels.

The flexible connecting means may be connected to the filter plates at formations spaced above the rollers or wheels to provide leverage for angularly displacing the filter plates.

The actuating means may include piston and cylinder assemblies located at opposite ends of the filter plates and adapted sequentially to tilt the filter plates in opposite directions.

Each piston and cylinder assembly may be connectable to the flexible connecting means by means of an electromagnetic arrangement.

Preferably an electromagnet is mounted on an end of a piston of the piston and cylinder assembly, and a magnetic connector is connected to the end of the flexible connecting means, the electromagnet being adapted to engage the magnetic connector when the electromagnet is activated while abutting the magnetic connector.

According to a further aspect of the invention the filter press disclosed above comprises

a support frame;
a plurality of filter plates mounted adjacent one another on the support frame,
the filter plates being displaceable between an inoperative position wherein adjacent filter plates are spaced apart, and an operative position wherein adjacent filter plates abut to form filtration cavities between abutting filter plates; and
   a cleaning device including a cleaning member associated with each filter plate, the cleaning device being displaceable relative to the filter plates when the filter plates are in their inoperative position so as to traverse the filtration cavities between the filter plates to clean filter cloths located in the filtration cavities.

The cleaning device may be a liquid spraying device that includes a header that is in liquid communication with a liquid supply source.

The cleaning members may be in the form of substantially T-shaped conduits extending from the header, the conduits having apertures through which liquid is discharged from the cleaning members to impinge on the filter plates and filter cloths located on the filter plates.

### BRIEF DESCRIPTION OF THE DRAWINGS

A preferred embodiment of the invention is described by way of a non-limiting example, and with reference to the accompanying drawings in which:

FIG. 1 is a perspective view of the filter press in accordance with the invention, with the filter plates being in an operative position;

FIG. 2 is a perspective view of part of the filter press of FIG. 1 without the cleaning device, and with the filter plates being spaced part in an inoperative position;

FIG. 3 is a perspective view of the filter press of FIG. 2, with the backing arrangement and filter plates being partially displaced towards the operative position;

FIG. 4 is a perspective view of the filter press of FIG. 2, with the filter plates abutting one another, but without a sealing force being imparted thereon;

FIG. 5 is a perspective view of the filter press of FIG. 2, with the filter plates abutting one another, and wherein the backing arrangement is locked relative to the support frame;

FIG. 6 is a perspective view of the filter press of FIG. 2, with the filter plates in an operative position wherein the backing arrangement imparts a sealing force on the filter plates;

FIG. 7 is a perspective view of the filter press of FIG. 2, with the filter plates being in an inoperative position, and being tilted to a first angularly displaced position;

FIG. 8 is a perspective view of the filter press of FIG. 7, wherein the filter plates are tilted to a second angularly displaced position;

FIG. 9 is a side view of the filter press of FIG. 1, wherein the cleaning device is in an inoperative, raised position;

FIG. 10 is a side view of the filter press of FIG. 9, wherein the cleaning device is lowered between the filter plates;

FIG. 11 shows the drive means used to tilt the filter plates as shown in FIGS. 7 and 8; and

FIG. 12 is a perspective view of the backing arrangement and some of the filter plates.

FIG. 13 is a perspective view of the filter plates of FIG. 12.

### DETAILED DESCRIPTION OF THE INVENTION

Referring to the drawings, in which like numerals indicate like features, a non-limiting example of a filter press in accordance with the invention is indicated by reference numeral 10. The filter press 10 includes a supporting frame 12 that carries a filter pack 20 and a backing arrangement 30. A cleaning device 60 extends upwardly from the support frame 12.

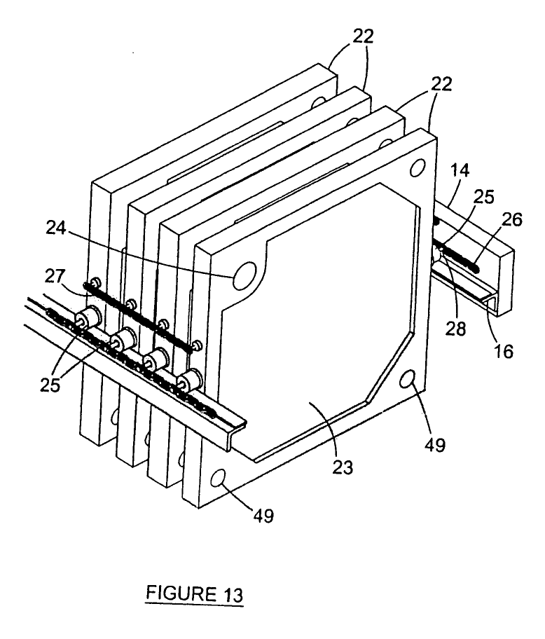

A filter pack 20 comprises a plurality of filter plates 22, and part of a filter pack 20 can best be seen in FIG. 13. Each filter plate 22 has a cavity 23 formed therein, the cavities being configured for adjacent filter plates 22 to form a filtration chamber (not shown) when they abut. The filter plates 22 also include internal inlet conduits 24 for feeding slurry into the filtration cavities, and internal outlet conduits 49 for discharging solid-free filtrate from the filtration cavities. Filter cloths (not shown), adapted to allow permeation of liquids therethrough, separate the filtration cavities from the internal outlet conduits 49.

A pair of rollers 25 extends from the sides of each filter plate 22. The rollers 25 are configured to engage tracks 16 provided on rails 14 extending along the length of the support frame 12. Adjacent filter plates 22 are connected by means of flexible connecting members in the form of displacement chains 26, which are used to pull the filter plates 22 apart. The displacement chain 26 is connected to shafts 28 extending beyond the rollers 25. A further flexible connecting means in the form of a tilting chain 27 extends between adjacent filter plates 22. The tilting chain 27 is connected to protrusions 29 extending from sides of the filter plates, which protrusions are located offset relative to a centerline of the filter plates 22 so as to be located in an operatively upper half of the filter plates. This configuration aids in facilitating a tilting action when a force is exerted on the tilting chain 27.

In the particular embodiment described hereinbefore, the filter pack 20 is made up of chamber filter plates 22. It will however be appreciated that the invention is not limited to the use of chamber filter plates, and that membrane filter plates (not shown), or a mix between membrane and chamber filter plates, may also be utilized.

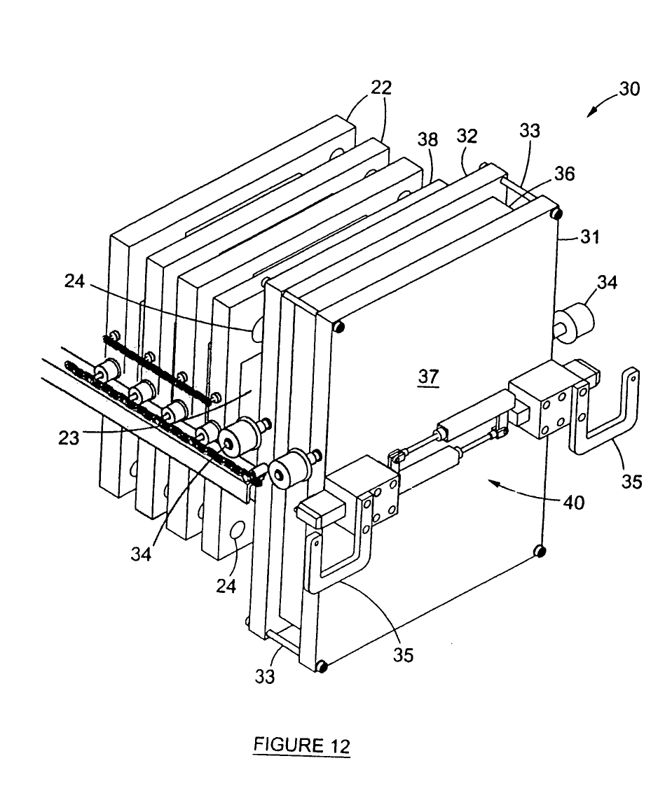

A backing arrangement 30 is located on the support frame 12 adjacent the outermost filter plate 38 of the filter pack 20. Referring to FIG. 12, the backing arrangement comprises a first backing plate 31, a second backing plate 32, and a pressure exerting mechanism in the form of a pressurizable bladder 36 sandwiched between the first 31 and second 32 backing plates. Each of the backing plates, 31 and 32, has a pair of opposing rollers 34 that extend from opposite sides thereof. The rollers 34 are configured to engage upper surfaces 17 of the rails 14 that extend along the length of the support frame 12. The backing plates, 31 and 32, are slideably connected to one another by means of rods 33 that engage apertures (not shown) provided in corners of the backing plates, 31 and 32. The pressurizable bladder 36 is located between the two backing plates, 31 and 32, and is in flow communication with a pressurization fluid. When the bladder 36 is pressurized, the second backing plate 32 is displaced away from the first backing plate 31 due to the backing plates being slideably connected.

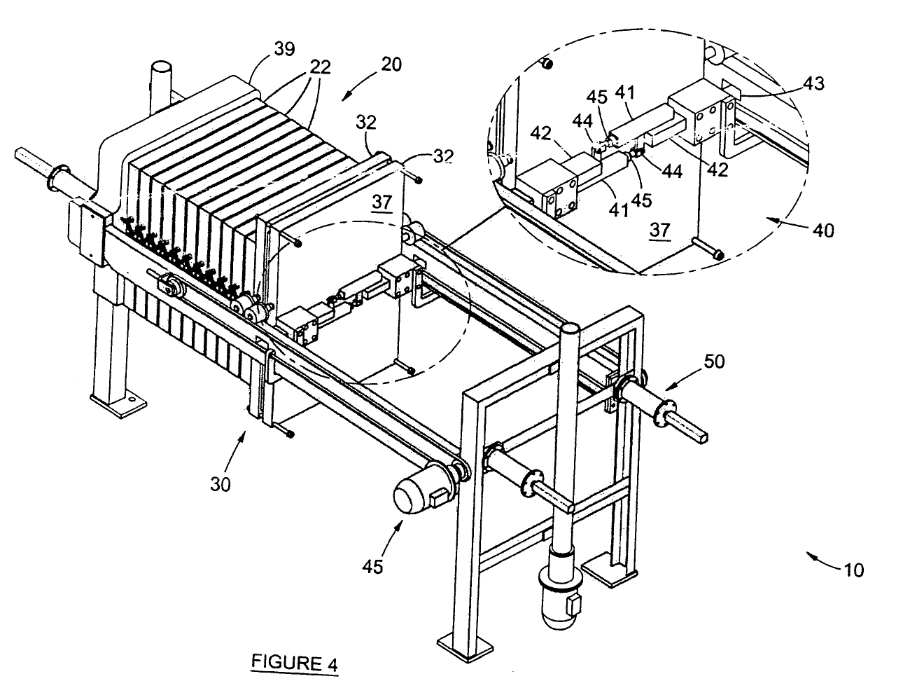

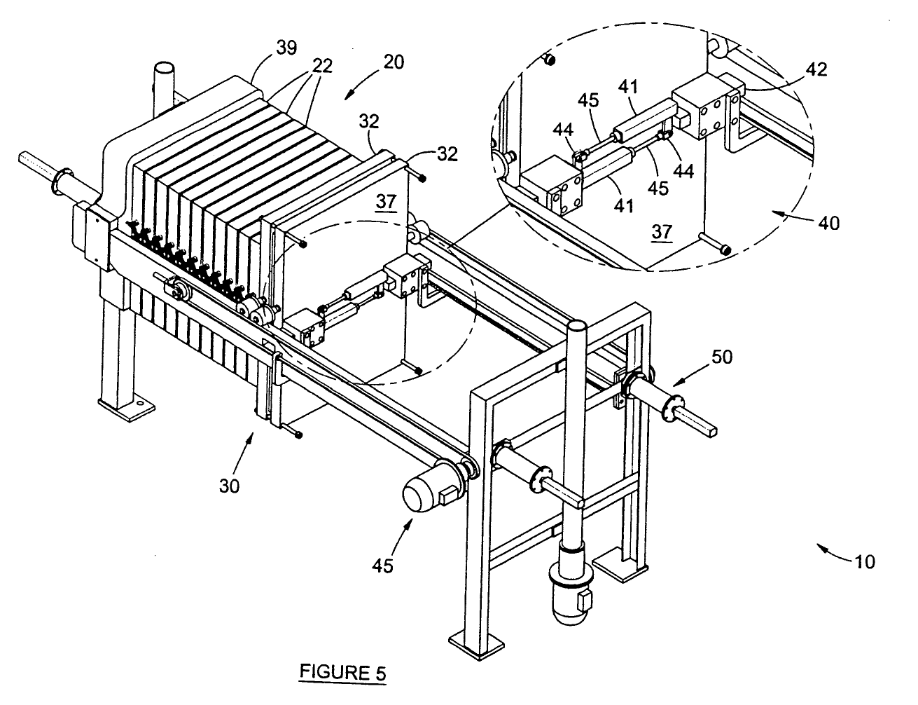

The first backing plate 31 also includes a locking mechanism 40 for use in locking the position of the first backing plate 31 relative to the rails 14 and thus the support frame 12. The locking mechanism 40, as seen in FIGS. 4 and 5, includes pistons 41 that are mounted on an outer surface 37 of the first backing plate 31. Ends 44 of the piston rods 45 are connected to locking members in the form of bolts 42 that are slideably mounted to the outer surface 37 of the first backing plate 31. The bolts 42 can be displaced to extend beyond a periphery of the first backing plate 31 so as to engage locking apertures 43 in the rails 14 of the supporting frame 12. When the bolts 42 engage such apertures 43 the first backing plate 31 is securely locked to the supporting frame in a fixed position.

The filter press also includes a stationary backing plate 39 at an end of the filter pack 20 opposite the backing arrangement 30. The filter pack 20 as a unit is therefore sandwiched between the stationary backing plate 39 and the backing arrangement 30.

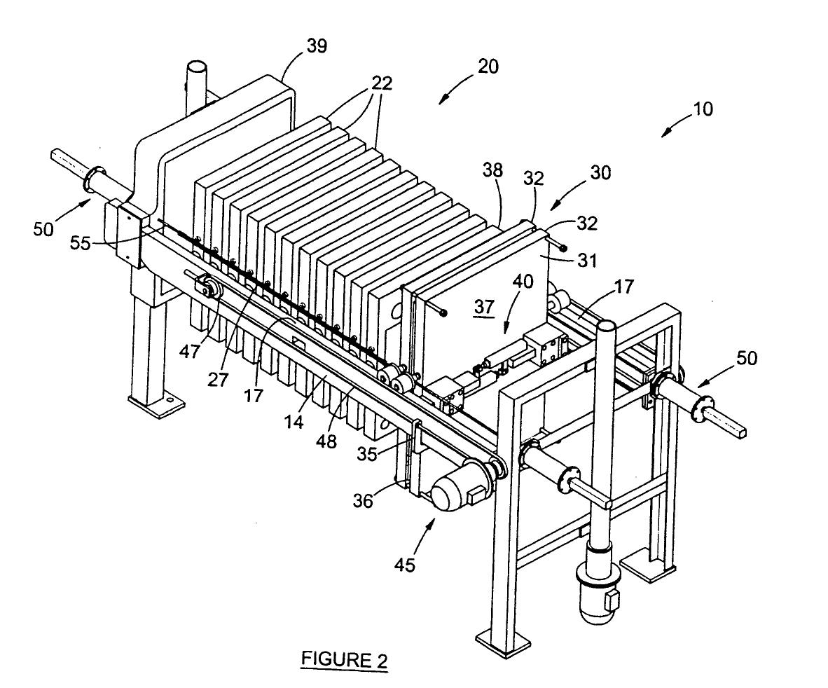

Drive means 45 in the form of a chain drive is provided for driving the backing arrangement 30, and thus also indirectly the filter plates 22. The drive means 45, as shown in FIG. 2, includes an electric motor 46, a set of pulleys 47, and an endless chain 48 rotating about the pulleys 47. A bracket 35 extends from the first backing plate 31 and is connected to the endless chain 48 so that rotation of the electric motor 46 causes the first backing plate 31, and therefore the complete backing arrangement 30, to be displaced along the rails 14. The electric motor 46 is bi-directional so that the backing arrangement 30 can be displaced both towards and away from the stationary backing plate 39.

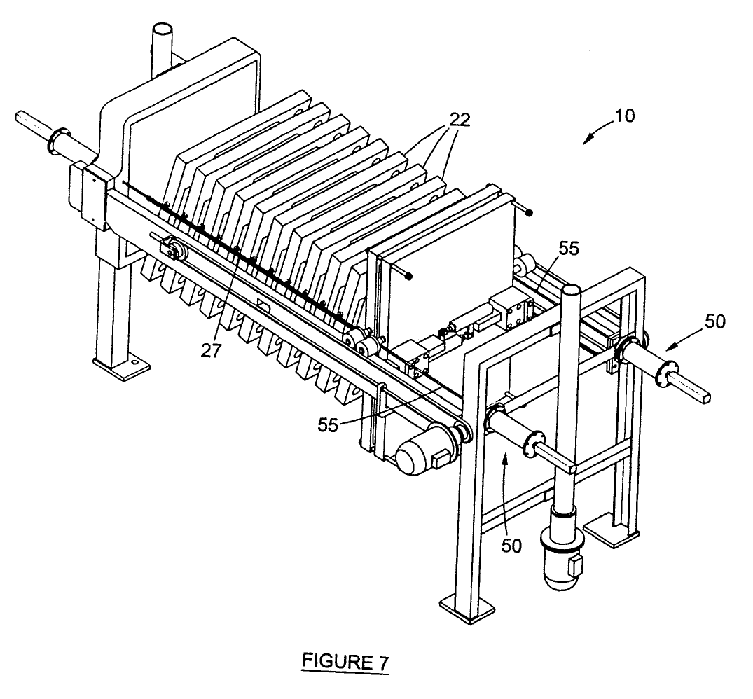

The filter press 10 further includes a filter plate 22 actuating device in the form of a tilting mechanism 50, which is shown in FIGS. 7, 8 and 11. The tilting mechanism 50 comprises a piston assembly 52 being connectable to the tilting chains 27 on the filter plates 22 by means of a tilting cable 55. The piston arrangement 52 has an electromagnet 54 located at the end of a piston rod 53. The tilting cable 55 terminates in an end section 56 made from a magnetic material. A flange 57 is provided for connecting the tilting mechanism 50 to the support frame 12. In the described embodiment a pair of tilting mechanisms 50 is provided on each side of the support frame 12.

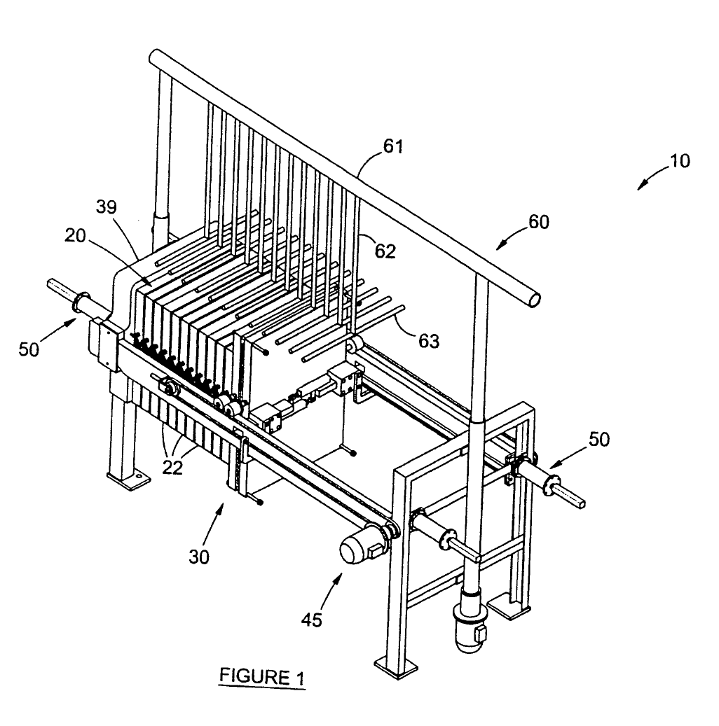

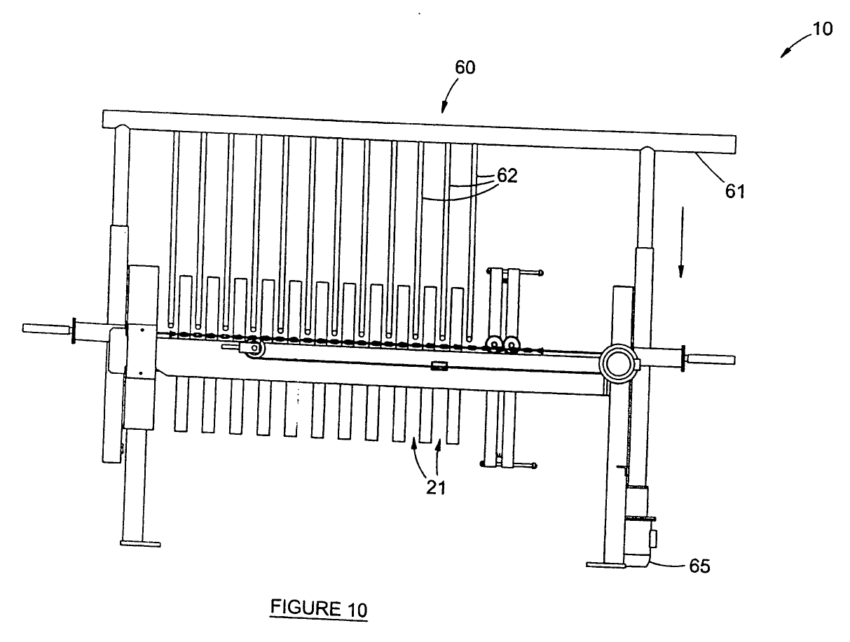

A cleaning device 60, shown in FIGS. 1, 9 and 10, is located above the filter press 10, and extends upwardly from the support frame 12. The cleaning device 60 is in the form of a water spraying device, and is used to clean the filter cloths (not shown) as well as the filter plates 22 when the filter pack 20 is in an inoperative position and the filter plates 22 are spaced apart. The cleaning device 60 includes a header 61, which is connected to a water supply source (not shown). The header 61 branches off into a plurality of T-shaped branches 62 having apertures in sides of horizontal sections 63 thereof. The branches 62, and more particularly the horizontal sections 63, are configured and dimensioned to fit in the gaps 21 between the spaced apart filter plates 22 when the filter pack 10 is in an inoperative position. The apertures are sideways orientated so as to direct fluid flow towards the filter plates 22 when located there between. The cleaning device 60 is moveable relative to the support frame 12, and is moved up and down by means of an electrical motor 65.

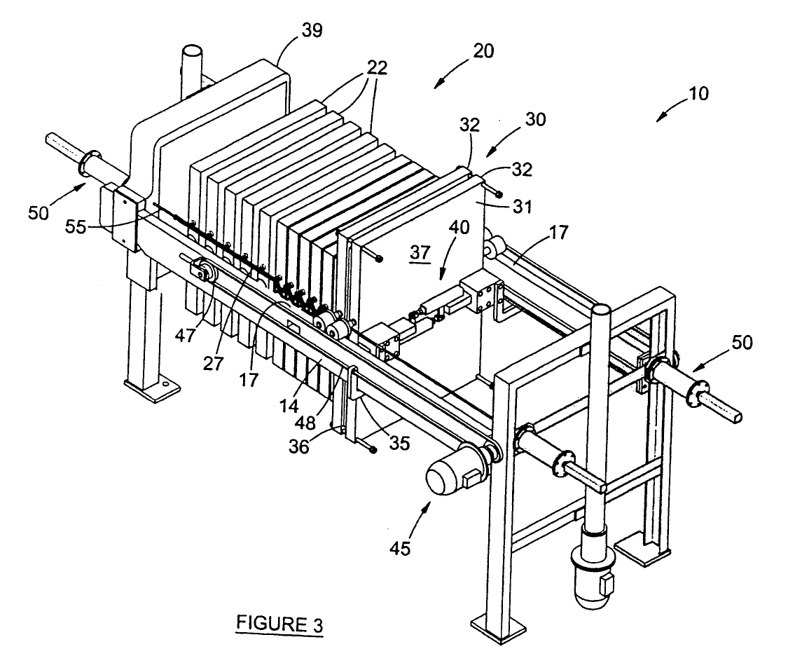

The operation of the press filter 10 is described with reference to FIGS. 2 to 10. In FIG. 2 the press filter 10 is shown with the filter pack 20 in an inoperative positions so that adjacent filter plates 22 are spaced apart to form gaps 21. The backing arrangement 30 is located towards an end of the support frame 12, and the bladder 36 is in a deflated position. When the chain drive 45 is activated, the electric motor 46 moves the backing arrangement 30 towards the stationary backing plate 39, and thus also towards the filter plates 22. Upon continued movement the second backing plate 32 engages the outermost filter plate 38, which in turn engages an adjacent filter plate 22 until all the filter plates are in close abutment as shown in FIG. 4. At this stage the force imparted by the chain drive 45 onto the backing arrangement 30 and thus the filter pack 20, is insufficient to provide a proper seal between adjacent filter plates 22.

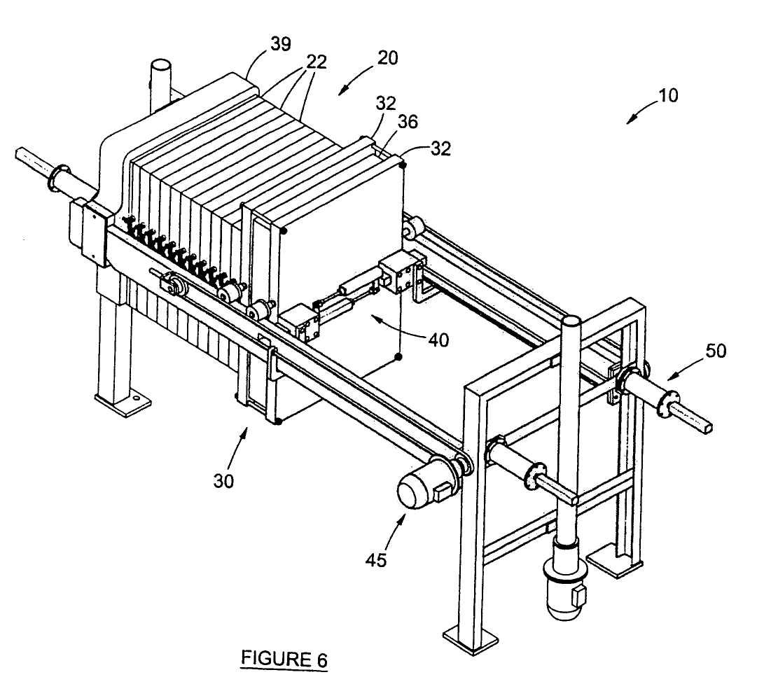

The first backing plate 31 is now locked into position by actuating the locking mechanism 45 as shown in FIG. 5. Once the first backing plate 31 is locked into position, the filter pack 20 is effectively sandwiched between two stationary backing plates, being the first backing plate 31 and the stationary backing plate 39. The bladder 36 can now be inflated by pressurization as shown in FIG. 6. As the bladder 36 expands, the second backing plate 32 is forced away from the first backing plate 31 towards the filter plates 22, due to the first backing plate 31 being securely locked in a stationary position. The second backing plate 32 therefore imparts a closing force on the outermost filter plate 38 which is transferred to the rest of the filter plates 22 so as to bring them all in sealing abutment, thus rendering the filter pack 20 operative. The filtration process subsequently commences, and occurs in a manner similar to the prior art.

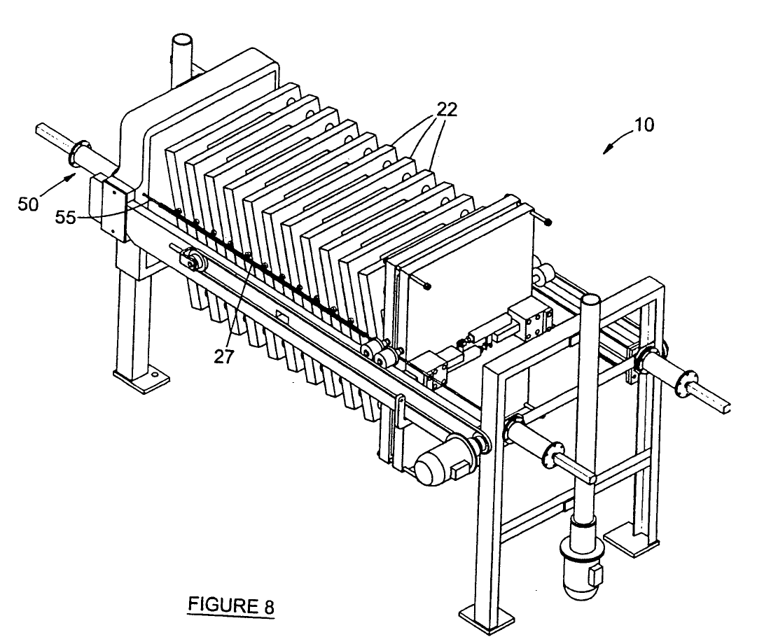

Once filtration has been completed, and a densely packed filter cake has been formed, the above operation is performed in reverse to return the press filter 10 to the position as shown in FIG. 2. Once the filter plates 22 are spaced apart as shown in FIG. 2, the filter cakes (not shown) must be removed. The filter cakes should in principle be automatically discharged under gravity, but experience has shown that the filter cakes often remain stuck in the cavities in the filter plates 22. To resolve this problem, the tilting mechanism 50 is now put in operation in order angularly to displace or to tilt the filter plates 22 in a to and fro motion between the orientations as shown in FIGS. 7 and 8. This angular displacement or tilting action assists in releasing the filter cakes from the filter plates 22.

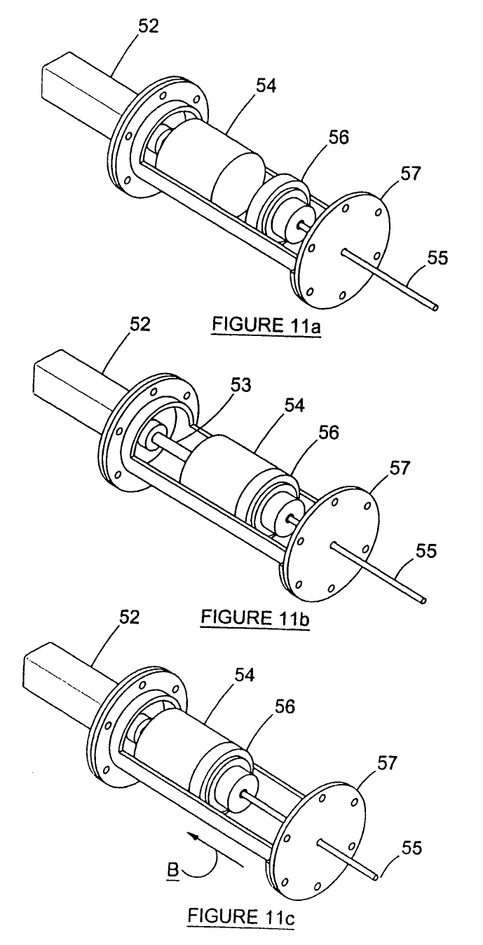

The operation of the tilting mechanism 50 is shown in FIG. 11a to 11c. In FIG. 11a the piston 52, and thus the electromagnet 54 located at an end of the piston rod 53, is disconnected from the magnetic end section 56 of the tilting cable 55. When the piston 52 is actuated, the electromagnet 54 is forced into abutment with the magnetic end section 56. Once the electromagnet 54 and the magnetic end section 56 abut, the electromagnet is energized so as to securely connect to the magnetic end section 56. When the piston rod 53 is subsequently returned to the starting position as shown in FIG. 11c, the tilting cable is 55 drawn towards the piston, in the direction indicated by arrow B, in order to tilt the filter plates 22 to which it is connected.

The filter plates 22 are first tilted in one direction and thereafter in an opposite direction. This is done by the sequential operation of the tilting mechanisms 50 on opposing ends of the support frame 12. This back and forth filter plate 22 movement causes the filter cakes (not shown) to become dislodged from the cavities 23 in the filter plates 22, and also from the filter cloth (not shown) to which it may be stuck. Importantly, the filter plates 22 are interconnected by means of the tilting chain 27 that connects adjacent filter plates 22. When the tilting mechanisms 50 are actuated the filter plates 22 tilt simultaneously as shown in FIGS. 7 and 8.

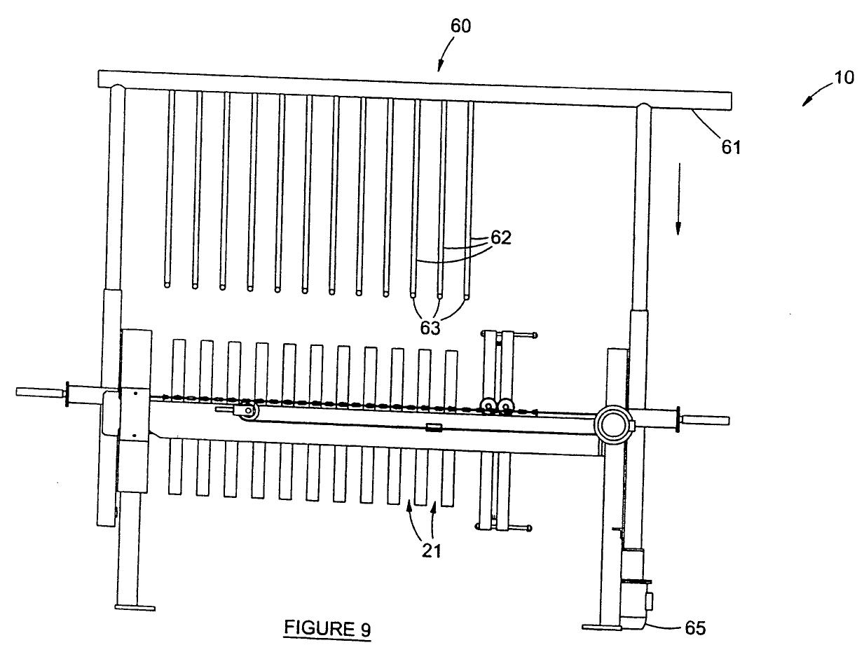

After the filter cakes have been removed from the filter plates 22, the filter plates 22 and more importantly the filter cloths (not shown) lining the filter plates 22, can be cleaned using the cleaning device 60. The filter plates 22 are first returned to a spaced apart, vertically orientated position shown in FIG. 9. The cleaning device 60 is subsequently lowered by the electrical motor 65 so that the branches 62 extending from the header 61 of the cleaning device 60 enters the gaps 21 between adjacent, spaced apart filter plates 22. Water, or any other suitable cleaning liquid, is pumped into the header at a high pressure, and subsequently discharged through the apertures in the horizontal sections 63 of the branches 62 in order for water jets to impinge on the filter cloth and filter plates 22 at high velocity to clean the same. The cleaning device 60 is adapted to travel along the full height of the filter plates 22 so as to clean the full face of each filter cloth (not shown) and filter plate 22.

It will be appreciated that the above is only one embodiment of the invention, and that there may be many variations in detail without departing from the spirit and scope of the invention.

1. A filter press comprising:
a support frame;
a plurality of filter plates mounted adjacent one another on the support frame, the filter plates being displaceable between an inoperative position wherein adjacent filter plates are spaced apart, and an operative position wherein adjacent filter plates abut to form filtration cavities between them;
the filter plates in their inoperative position being angularly displaceable relative to the support frame; and
actuating means adapted angularly to displace the filter plates relative to the support frame so as to discharge filter cake from the filtration cavities.

2. The filter press according to claim 1 including connecting means for connecting adjacent filter plates such that the actuating means displaces the filter plates simultaneously in a to and fro motion.

3. The filter press according to claim 2 wherein the connecting means comprises an elongate flexible member such as a chain.

4. The filter press according to any one of claims 1 to 3 wherein each filter plate includes track engagement means extending from opposed sides thereof for supporting the filter plates on spaced tracks provided on the support frame.

5. The filter press according to claim 4 wherein each filter plate is pivotally mounted by the track engagement means for movement between a substantially vertical position and an angularly displaced position.

6. The filter press according to any one of claims 3 to 5 wherein the track engagement means comprises rollers or wheels.

7. The filter press according to any one of claims 2 to 6 wherein the connecting means is connected to each filter plate at connecting formations spaced from the track engagement means to provide leverage for angularly displacing the filter plates.

8. A filter press according to any one of claims 1 to 7 including piston and cylinder assemblies located at opposite ends of the plurality of filter plates, and adapted sequentially to displace the filter plates angularly in opposite directions.

9. The filter press according to claim 8 wherein each piston and cylinder assembly is connectable to the flexible connecting means by means of an electromagnetic arrangement.

10. The filter press according to claim 9 wherein an electromagnet is mounted at one end of a piston of a piston and cylinder assembly adapted to tilt the filter plates to an angularly displaced position, and a magnetic connector is connected to the end of the connecting means, the electromagnet being adapted to engage the magnetic connector when the electromagnet is activated while abutting the magnetic connector.

11. The filter press according to any one of claims 1 to 10 including a cleaning device having a cleaning member associated with each filter plate, the cleaning device being displaceable relative to the filter plates when the filter plates are in their inoperative position so as to traverse the filtration cavities between the filter plates to clean filter cloths located in the filtration cavities.

12. The filter press according to claim 11 wherein the cleaning device is a liquid spraying device which includes a header in liquid communication with a liquid supply source.

13. The filter press according to claim 12 wherein the cleaning members are in the form of substantially T-shaped conduits extending from the header, the conduits having apertures through which liquid is discharged from the cleaning members to impinge on the filter plates and filter cloths located on the filter plates.

14. A filter press according to any one of the preceding claims including a cleaning device comprising a cleaning member associated with each filter plate, the cleaning device being displaceable relative to the filter plates when the filter plates are in their inoperative position so as to traverse the filtration cavities between the filter plates to clean filter cloths located in the filtration cavities.

15. The filter press according to claim 14 wherein the cleaning device comprises a liquid spraying device that includes a header that is in liquid communication with a liquid supply source.

16. The filter press according to claim 14 wherein the cleaning members are in the form of substantially T-shaped conduits extending from the header, the conduits having apertures through which liquid is discharged from the cleaning members to impinge on the filter plates and filter cloths located in the filter plates.

17. A filter press substantially as herein described and exemplified with reference to the accompanying drawings.
